(19) United States
(12) Patent Application Publication
(10) Pub. No.: US 2025/0299125 A1
(43) Pub. Date: Sep. 25, 2025

(54) INFORMATION PROCESSING SYSTEM, INFORMATION PROCESSING METHOD, AND INFORMATION PROCESSING DEVICE

(71) Applicant: Tomotaro HOSHIKA, Kanagawa (JP)

(72) Inventor: Tomotaro HOSHIKA, Kanagawa (JP)

(73) Assignee: Ricoh Company, Ltd., Tokyo (JP)

(21) Appl. No.: 19/022,197

(22) Filed: Jan. 15, 2025

(30) Foreign Application Priority Data
Mar. 22, 2024 (JP) 2024-045900
Nov. 25, 2024 (JP) 2024-204826

(51) Int. Cl. G06Q 10/0631; G06Q 10/30

(52) U.S. Cl. CPC G06Q 10/06313; G06Q 10/30

(57) ABSTRACT

An information processing system includes first and second memories and circuitry. The first memory records job information of one or more apparatuses including a replaceable consumable item. The circuitry calculates an amount of the item consumed by execution of a job of the one or more apparatuses based on the job information and plans maintenance for replacement of the item based on a remaining amount of the item and the calculated amount to prevent the remaining amount from being not greater than a value. The second memory stores a table including a time required for maintenance, required number of maintenance performers, and whether maintenance is performable ahead of schedule. The circuitry plans maintenance performable ahead of schedule when number of users available to perform the maintenance is smaller than the required number when maintenance schedules overlap and the maintenance performable ahead of schedule is present, based on the table.

### CROSS-REFERENCE TO RELATED APPLICATIONS

This patent application is based on and claims priority pursuant to 35 U.S.C. § 119(a) to Japanese Patent Application Nos. 2024-045900, filed on Mar. 22, 2024, and 2024-204826, filed on Nov. 25, 2024, in the Japan Patent Office, the entire disclosure of each of which is hereby incorporated by reference herein.

### BACKGROUND

### Technical Field

Embodiments of the present disclosure relate to an information processing system, an information processing method, and an information processing device.

### Related Art

For image forming apparatuses in the related art, the time when consumable items (consumable supplies such as paper, toner, and Preventive Maintenance (PM) parts) of each apparatus run out and the time when maintenance work occurs can be predicted. Thus, the maintenance can be planned by detecting a failure or a sign of the failure. When the consumable items of multiple image forming apparatuses in use run out at the same time, maintenance work may be required for the multiple image forming apparatuses at the same time.

### SUMMARY

According to an embodiment of the present disclosure, an information processing system includes a first memory, circuitry, and a second memory. The first memory records job information of one or more apparatuses including a replaceable consumable item. The circuitry calculates an amount of the consumable item consumed by execution of a job of the one or more apparatuses based on the job information to obtain a calculated amount of consumption and plans maintenance for replacement of the consumable item based on a remaining amount of the consumable item and the calculated amount of consumption to prevent the remaining amount of the consumable item from being equal to or smaller than a predetermined value. The second memory stores a maintenance information value table including, for each type of the maintenance, a time required for the maintenance, required number of maintenance performers, and whether the maintenance is performable ahead of schedule. The circuitry plans maintenance performable ahead of schedule in a case where number of users available to perform the maintenance is smaller than the required number of maintenance performers at a time when a plurality of maintenance schedules overlap and the maintenance performable ahead of schedule is present, based on the maintenance information value table.

According to an embodiment of the present disclosure, an information processing method includes calculating an amount of a replaceable consumable item consumed by execution of a job of one or more apparatuses including the consumable item based on job information of the one or more apparatuses to obtain a calculated amount of consumption, planning maintenance for replacement of the consumable item based on a remaining amount of the consumable item and the calculated amount of consumption to prevent the remaining amount of the consumable item from being equal to or smaller than a predetermined value, and planning maintenance performable ahead of schedule in a case where number of users available to perform the maintenance is smaller than required number of maintenance performers at a time when a plurality of maintenance schedules overlap and the maintenance performable ahead of schedule is present.

According to an embodiment of the present disclosure, an information processing device includes a first memory, circuitry, and a second memory. The first memory records job information of one or more apparatuses including a replaceable consumable item. The circuitry calculates an amount of the consumable item consumed by execution of a job of the one or more apparatuses based on the job information to obtain a calculated amount of consumption and plans maintenance for replacement of the consumable item based on a remaining amount of the consumable item and the calculated amount of consumption to prevent the remaining amount of the consumable item from being equal to or smaller than a predetermined value. The second memory stores a maintenance information value table including, for each type of the maintenance, a time required for the maintenance, required number of maintenance performers, and whether the maintenance is performable ahead of schedule. The circuitry plans maintenance performable ahead of schedule in a case where number of users available to perform the maintenance is smaller than the required number of maintenance performers at a time when a plurality of maintenance schedules overlap and the maintenance performable ahead of schedule is present, based on the maintenance information value table.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating an example of a configuration of an information processing system;

FIG. 2 is a block diagram illustrating an example of a system used for image forming apparatuses;

FIG. 3 is a flowchart illustrating an example of a process of an information processing device to determine when to perform maintenance and who performs the maintenance;

FIG. 4 is a maintenance information value table in the information processing device of FIG. 3;

FIG. 5 is a diagram illustrating an example of a user interface (UI) displaying a notification that maintenance is planned ahead of schedule on the information processing device of FIG. 3;

FIG. 6 is a diagram illustrating an example of the UI displaying a notification that the order of jobs is changed and maintenance is planned on the information processing device of FIG. 3;

FIG. 7 is a diagram illustrating an example of the UI displaying a notification that maintenance is planned and there is a shortage of maintenance performers on the information processing device of FIG. 3;

FIG. 8 is a diagram illustrating an example of a process to determine when to perform maintenance of the image forming apparatus of FIG. 2; and

FIG. 9 is a diagram illustrating an example of a process to determine when to perform maintenance and who performs the maintenance of the image forming apparatus of FIG. 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, like reference signs denote like elements such as parts and materials having the same functions, and redundant descriptions thereof are omitted unless otherwise required.

Embodiments of an information processing system, an information processing method, and an information processing device will be described in detail below with reference to the accompanying drawings.

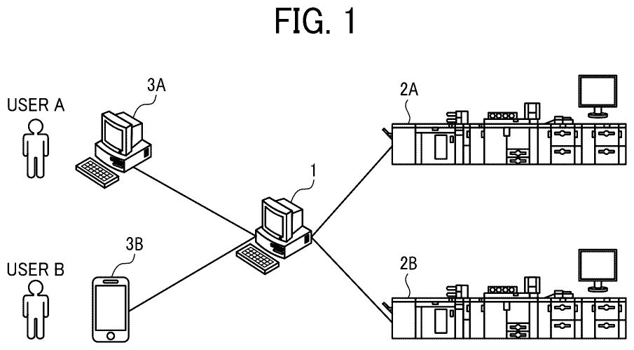

FIG. 1 is a block diagram illustrating a configuration of an information processing system according to the present embodiment. The information processing system according to the present embodiment includes an information processing device 1, multiple image forming apparatuses 2A and 2B, and multiple terminal devices 3A and 3B used individually by multiple users A and B. In the following description, the multiple image forming apparatuses 2A and 2B may be collectively referred to as the image forming apparatuses 2 whereas the multiple terminal devices 3A and 3B may be collectively referred to as the terminal devices 3.

The information processing device 1 can receive information on the remaining amount of consumable supplies (consumable items) from the image forming apparatuses 2. The information processing device 1 can mutually communicate with the image forming apparatuses 2 and the terminal devices 3. In the above-described system configuration, the functions of the information processing device 1 may be included as a part of the image forming apparatuses 2.

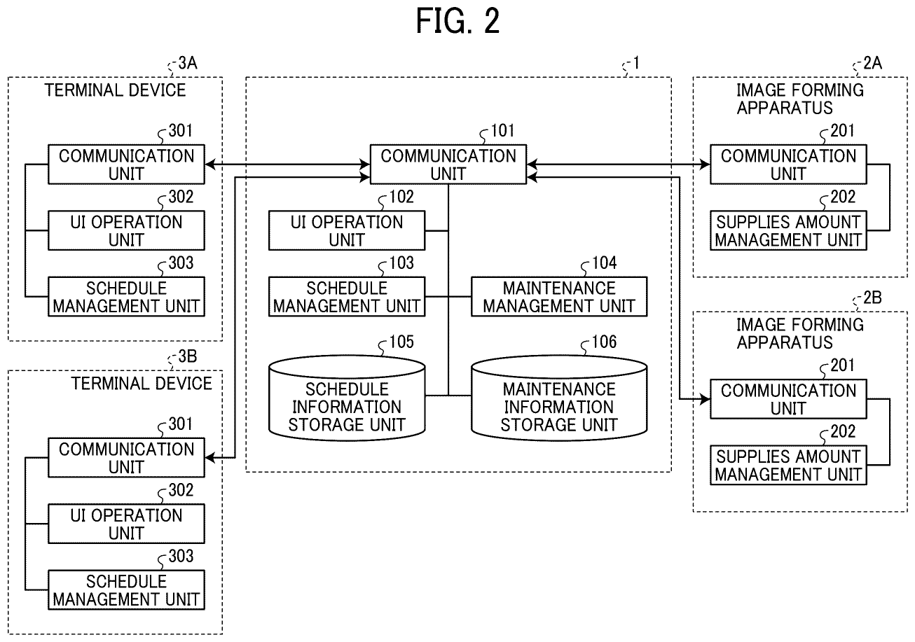

FIG. 2 is a block diagram illustrating a system used for the image forming apparatuses 2 according to the present embodiment. Each of the image forming apparatuses 2 according to the present embodiment is an example of an apparatus that includes replaceable consumable items. In the present embodiment, the image forming apparatus 2 will be described as an example of an apparatus of which a model to be managed is registered and centrally managed. However, the apparatus is not limited to the image forming apparatus 2 as long as the apparatus includes replaceable consumable items. Each of the image forming apparatus 2 according to the present embodiment includes a communication unit 201 and a supplies amount management unit 202. The communication unit 201 can communicate with the information processing device 1. The supplies amount management unit 202 measures the remaining amount of consumable supplies (consumable items) such as paper, ink, and toner, and transmits the remaining amount to the information processing device 1 through the communication unit 201. The consumable items may include replaceable items (so-called parts) such as a photoconductor, a transfer member, a blade, and a roller.

Each of the terminal devices 3 includes a communication unit 301, a user interface (UI) operation unit 302, and a schedule management unit 303. The communication unit 301 can communicate with the information processing device 1. The UI operation unit 302 displays, for example, schedule information on the maintenance of the image forming apparatus 2. The schedule management unit 303 stores the schedule information on the maintenance of the image forming apparatus 2. The schedule management unit 303 stores the schedule information of the corresponding terminal device 3.

The information processing device 1 is an example of an information processing device that includes a communication unit 101, a UI operation unit 102, a schedule management unit 103, a maintenance management unit 104, a schedule information storage unit 105, and a maintenance information storage unit 106. The communication unit 101 transmits and receives information on the remaining amount of consumable supplies from the image forming apparatuses 2 and schedule information of the users.

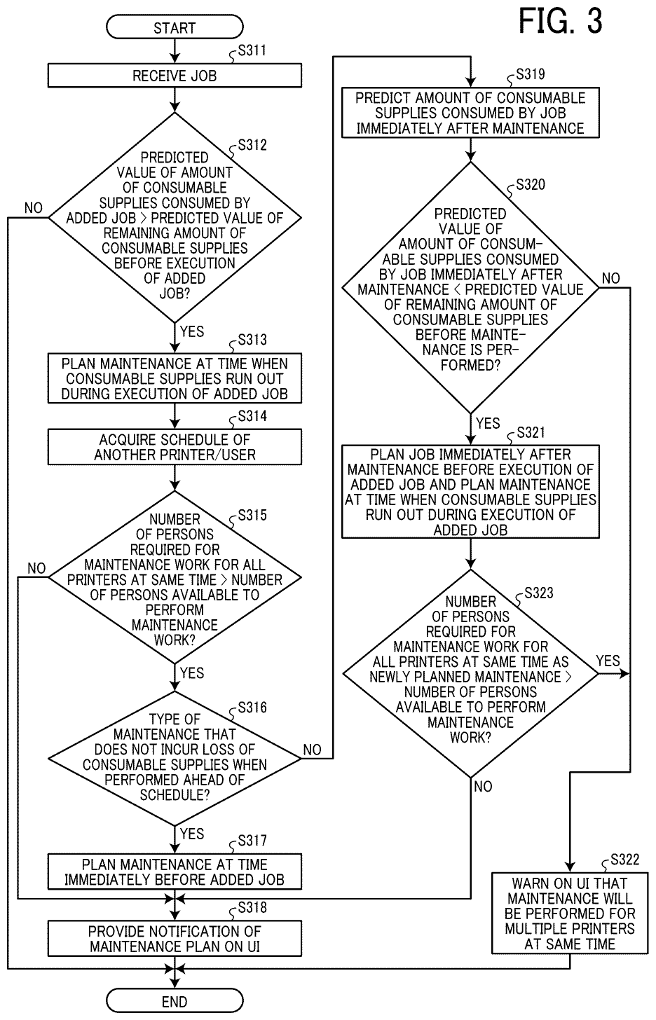

The schedule management unit 103 stores, in the schedule information storage unit 105, schedule information including job information indicating a job to be executed on the image forming apparatus 2, when to perform maintenance for replacement of consumable supplies of the image forming apparatus 2, and who performs the maintenance. In other words, the schedule information storage unit 105 is an example of a job information recording unit that records job information of the image forming apparatus 2. When a job is newly added to the image forming apparatus 2 or when the content of the job of the image forming apparatus 2 is updated, the schedule management unit 103 determines whether maintenance is necessary based on a predicted value of the amount of consumable supplies consumed by execution of the job and the remaining amount of the consumable supplies of the image forming apparatus 2. The schedule management unit 103 starts to plan maintenance when the schedule management unit 103 determines that maintenance is necessary due to a shortage of the consumable supplies. The schedule management unit 103 functions as an example of a schedule management unit that registers a schedule of maintenance in the schedule information (an example of a schedule) of a user assigned as a maintenance performer (user) who performs maintenance work by the maintenance management unit 104. Thus, the schedule of maintenance is registered in the schedule information of the terminal device 3 used by the user. The flow of a process from the addition of a job to the determination of a maintenance plan will be described later with reference to a flowchart illustrated in FIG. 3.

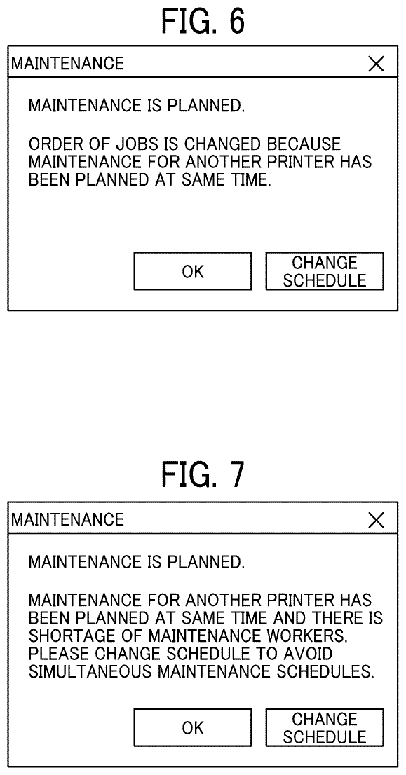

When the schedule management unit 103 determines when to perform the maintenance, the UI operation unit 102 displays a notification dialog as illustrated in FIG. 5, FIG. 6, or FIG. 7 to notify the user of a maintenance plan.

The maintenance management unit 104 stores maintenance information on the replacement of consumable supplies of the image forming apparatus 2 in the maintenance information storage unit 106 and reads a maintenance information value table from the maintenance information storage unit 106.

A description is given below of an example of specific operations of the schedule management unit 103. The schedule management unit 103 is an example of a consumables consumption calculating unit that calculates the amount of consumable supplies consumed by execution of the job of the image forming apparatus 2, based on the job information included in the schedule information stored in the schedule information storage unit 105.

For example, the consumables consumption calculating unit of the image forming apparatus 2 predicts and calculates the consumed amount of paper based on the information on the number of sheets to be printed in the information of a job to be executed. As another example, the consumables consumption calculating unit predicts the amount of toner or ink to be used, based on the color information of the print image data in the information of a job to be executed, and calculates the amount of consumption of the toner or ink. Instead of or in addition to the information of a job to be executed including the information on the number of sheets to be printed or the print image data, for example, the consumables consumption calculating unit may record the amount of consumable items used by execution of a previous job as a result and create a model for predicting the amount of consumption by machine learning based on the result as an input, to calculate the amount of consumption of each consumable item. In this way, the amount of consumption of consumable items is quickly detected by advanced analysis functions and artificial intelligence (AI) and operation history data is utilized to reduce the downtime caused by maintenance. The schedule management unit 103 is an example of a remaining amount calculating unit that calculates the remaining amount of consumable supplies immediately before a job is added to the image forming apparatus 2, based on the information on the remaining amount of consumable supplies from the image forming apparatus 2. The schedule management unit 103 is also an example of a maintenance planning unit that plans the maintenance for replacement of consumable supplies based on the remaining amount of the consumable supplies of the image forming apparatus 2 and the calculated amount of consumption to prevent the remaining amount of the consumable supplies from being empty. “The remaining amount of the consumable supplies being empty” includes the remaining amount of the consumable supplies being equal to or smaller than a preset amount (an example of a predetermined value). For example, in a case where the consumable supplies (consumable item) is a cleaning blade, “the remaining amount of the consumable supplies being empty” may be the detection of distortion of the cleaning blade or the detection of residual toner slipping through a blade nip.

In a case where the consumable supplies (consumable item) is a liquid such as toner or ink, “the remaining amount of the consumable supplies being empty” may be a weight or level of the liquid measured by a weight sensor or a distance sensor being equal to or smaller than a predetermined value (e.g., the weight or level of the liquid being 90% or less of a default value). In a case where the consumable supplies (consumable item) is a photoconductor or a part of a transfer unit, “the remaining amount of the consumable supplies being empty” may be a difference between a use limit value and a recorded value of the number of rotations used, a distance used, a time used, and the number of days used of the photoconductor or the part of the transfer unit being equal to or smaller than a predetermined value. In a case where the consumable supplies (consumable item) is a roller, “the remaining amount of the consumable supplies being empty” may be the remaining amount of the roller based on the amount of wear of the roller measured by a distance sensor being equal to or smaller than a predetermined value. The remaining amount calculating unit of the image forming apparatus 2 calculates the remaining amount based on, for example, the weight of a consumable item in a replenishment unit of the image forming apparatuses 2 measured by a weight sensor disposed in the replenishment unit. Alternatively, the remaining amount calculating unit may calculate the remaining amount based on, for example, the thickness or liquid level of a consumable item in the replenishment unit of the image forming apparatus 2 measured by an optical sensor or a camera disposed in the replenishment unit.

The maintenance information storage unit 106 is an example of a maintenance information recording (storing) unit in which a maintenance information value table is recorded (stored). The maintenance information value table records, for each maintenance type, specific values such as the number of persons required to perform the maintenance, the time required to perform the maintenance, and whether the maintenance can be performed ahead of schedule. Whether the maintenance can be performed ahead of schedule may be determined based on whether performing the maintenance ahead of schedule incurs the consumption (loss) of the consumable supplies.

For example, the replenishment of paper is determined as maintenance that can be performed ahead of schedule because the amount of consumption of paper remains unchanged when paper is replenished ahead of schedule. By contrast, the replenishment of consumable supplies such as toner or ink is determined as maintenance that cannot be performed ahead of schedule because the replenishment of toner or ink is accompanied by the replacement of a toner or ink container (e.g., a bottle or cartridge) in use with a new container, thus incurring the consumption (loss) of the residual toner or ink in the container in use when the replenishment is performed ahead of schedule.

In the present embodiment, when calculating the number of persons available to perform maintenance, the schedule management unit 103 acquires schedule information of users using the terminal devices 3 through the communication unit 101, determines whether the users are available to perform maintenance, and obtains the total number of users available to perform maintenance, thus calculating the number of persons available to perform maintenance for each time.

In the present embodiment, when the information processing device 1 determines the maintenance schedule and the maintenance performer, the maintenance schedule information is transmitted to the terminal device 3 of the maintenance performer through the communication unit 101, the maintenance schedule is registered in the schedule management unit 303 of the terminal device 3, and the maintenance schedule information is displayed on the UI operation unit 102.

Specifically, the schedule management unit 103 plans maintenance that can be performed ahead of schedule in a case where the number of users available to perform maintenance work is smaller than the required number of maintenance performers (i.e., the number of persons required to perform the maintenance work) at the time when multiple maintenance schedules overlap and the maintenance that can be performed ahead of schedule is present, based on the maintenance information value table. This prevents the image forming apparatus 2 from waiting for maintenance work due to a shortage of maintenance performers while reducing the consumption of consumable supplies caused by the maintenance for replacement of consumable supplies being performed ahead of schedule.

By contrast, in a case where the number of users available to perform maintenance work is smaller than the required number of maintenance performers at the time when multiple maintenance schedules overlap and the maintenance that can be performed ahead of schedule is absent, the schedule management unit 103 plans, before maintenance, a forward movable job which is planned after the time when the multiple maintenance schedules overlap and which does not empty the remaining amount of consumable supplies when the forward movable job is executed before the maintenance. Thus, the image forming apparatus 2 is prevented from waiting for the maintenance that cannot be performed ahead of schedule due to a shortage of maintenance performers while reducing the consumption of consumable supplies by replacing the jobs.

The schedule management unit 103 is an example of a display control unit that displays a plan change notification on a display unit such as the UI operation unit 102 in a case where the execution of the maintenance that can be performed ahead of schedule or the forward movable job is planned ahead of schedule. The schedule management unit 103 is also an example of a warning unit that warns through the UI operation unit 102 that a time during which the number of maintenance performers is insufficient is present in a case where the number of users available to perform maintenance work is smaller than the required number of maintenance performers at the time when multiple maintenance schedules overlap and neither the maintenance that can be performed ahead of schedule nor the forward movable job is present or the execution of the maintenance that can be performed ahead of schedule or the forward movable job is planned ahead of schedule. Thus, the user can be notified of the occurrence of downtime of the image forming apparatus 2 due to a shortage of maintenance performers. For example, the schedule management unit 103 may output a sound such as a voice from the UI operation unit 102 to warn that the time during which the number of maintenance performers is insufficient is present. Alternatively, the schedule management unit 103 may blink a display unit such as the UI operation unit 102 to warn that the time during which the number of maintenance performers is insufficient is present.

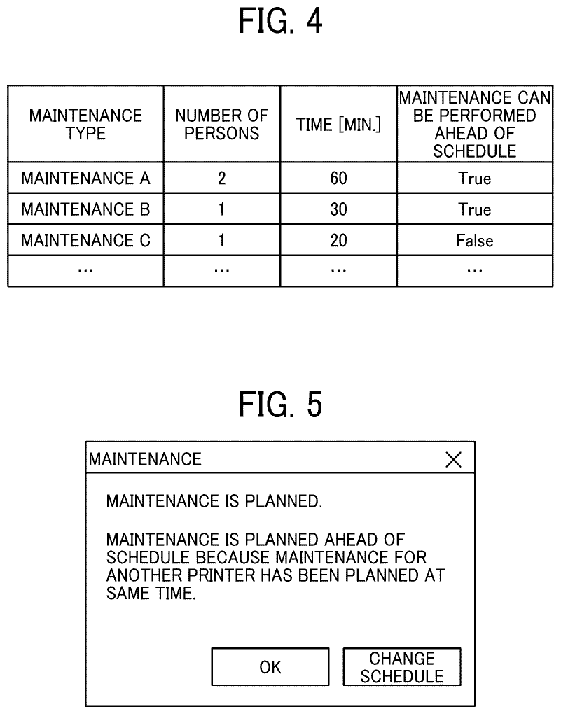

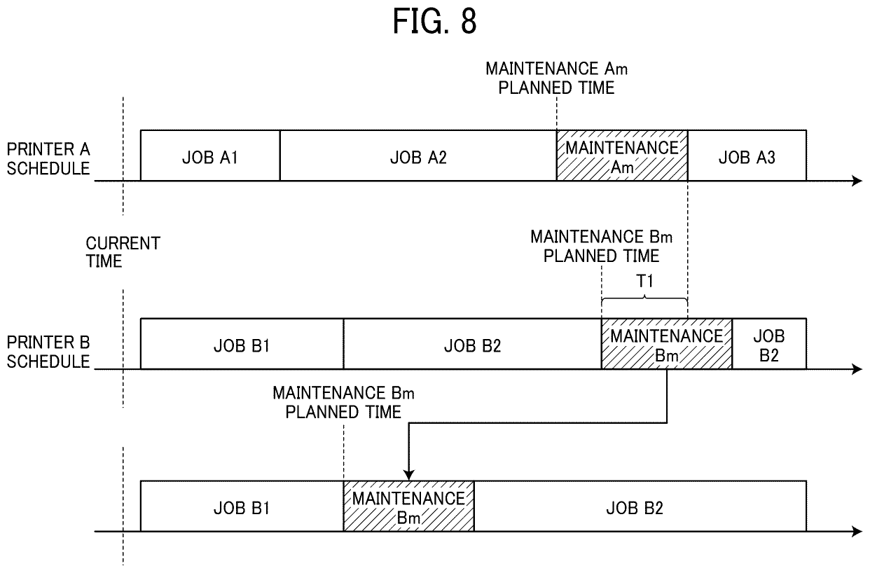

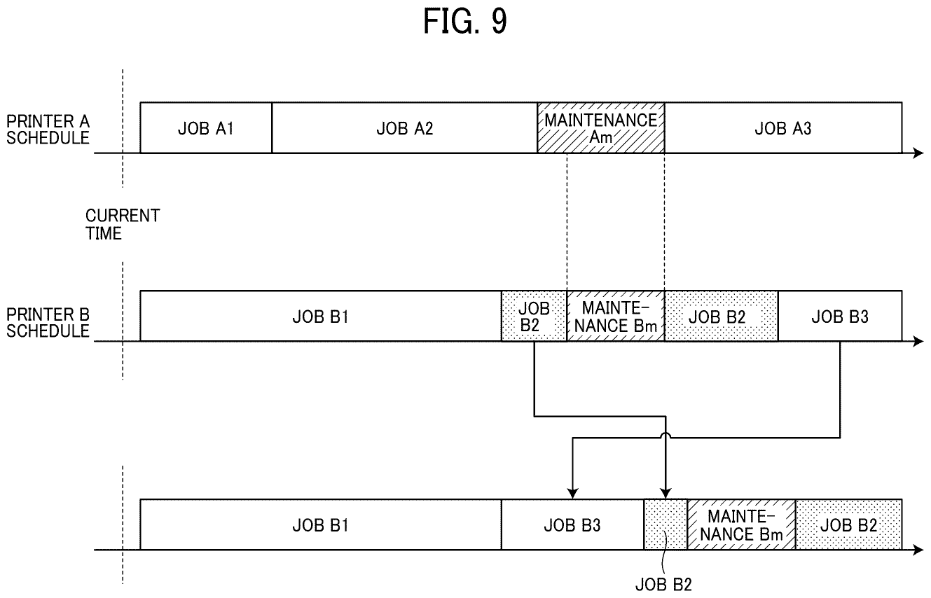

FIG. 3 is a flowchart illustrating a process of the information processing device 1 to determine when to perform maintenance and who performs the maintenance according to the present embodiment. This process is executed by the schedule management unit 103 of the information processing device 1 illustrated in FIG. 2. FIG. 4 is a maintenance information value table in the information processing device 1 according to the present embodiment. FIG. 5 is a diagram illustrating an example of a UI displaying a notification that maintenance is planned ahead of schedule on the information processing device 1 according to the present embodiment. FIG. 6 is a diagram illustrating an example of the UI displaying a notification that the order of jobs is changed and maintenance is planned on the information processing device 1 according to the present embodiment. FIG. 7 is a diagram illustrating an example of the UI displaying a notification that maintenance is planned and there is a shortage of maintenance performers on the information processing device 1 according to the present embodiment. FIG. 8 is a diagram illustrating a process to determine when to perform maintenance of the image forming apparatus 2 according to the present embodiment. FIG. 9 is a diagram illustrating a process to determine when to perform maintenance and who performs the maintenance of the image forming apparatus 2 according to the present embodiment.

In step S311, the schedule management unit 103 receives a new job and starts to plan maintenance. The schedule management unit 103 calculates the amount of various consumable supplies to be consumed by execution of the added (received) job (predicted value of the amount of consumable supplies to be consumed by execution of the added job) based on the job information such as the number of sheets to be printed and the image information of the added job. At the same time, the schedule management unit 103 calculates the remaining amount of various consumable supplies immediately before the job is added (predicted value of the remaining amount of consumable supplies before the added job is executed). In step S312, the schedule management unit 103 compares the predicted value of the amount of consumable supplies consumed by execution of the added job with the predicted value of the remaining amount of consumable supplies before the added job is executed.

When the predicted value of the amount of consumable supplies consumed by execution of the added job is equal to or smaller than the predicted value of the remaining amount of consumable supplies before the added job is executed (NO in step S312), the schedule management unit 103 determines that the consumable supplies will not run out and ends the process without planning maintenance.

By contrast, when the predicted value of the amount of consumable supplies consumed by execution of the added job is greater than the predicted value of the remaining amount of consumable supplies before the added job is executed (YES in step S312), in step S313, the schedule management unit 103 determines that the consumable supplies may run out after or during the execution of the job and plans maintenance at the time (execution time) when the consumable supplies run out during the execution of the job.

In step S314, the schedule management unit 103 acquires the maintenance schedule of an apparatus other than the image forming apparatus 2 to which the job is input and the schedule of the user from the schedule information storage unit 105 for the execution time at which the maintenance is planned. The schedule management unit 103 calculates the number of persons required to perform maintenance work for all the image forming apparatuses 2 at the same time (execution time), based on the maintenance schedule of the other image forming apparatuses 2 at the time when the maintenance is planned. The number of persons required to perform maintenance work for all the image forming apparatuses 2 is calculated based on the information of the number of persons required to perform maintenance set for each maintenance type in the maintenance information value table.

The schedule management unit 103 also acquires the schedule of the user for the time during which the maintenance is planned from the schedule information storage unit 105 and determines whether the idle time is present, thus calculating the number of persons available to perform maintenance work at the same time. In step S315, the schedule management unit 103 compares the number of persons required to perform maintenance work for all the image forming apparatuses 2 with the number of persons available to perform maintenance work.

When the number of persons required to perform maintenance work for all the image forming apparatuses 2 at the same time is equal to or smaller than the number of persons available to perform maintenance work (NO in step S315), in step S318, the schedule management unit 103 can determine that the image forming apparatuses 2 may not need to wait for maintenance work due to a shortage of the number of persons available to perform maintenance work, thus planning the maintenance without changing the scheduled maintenance time, providing a notification that maintenance is newly planned on the UI operation unit 102, and ending the process illustrated in FIG. 3.

By contrast, when the number of persons required to perform maintenance work for all the image forming apparatuses 2 at the same time is greater than the number of persons available to perform maintenance work (YES in step S315), the schedule management unit 103 can determine that the image forming apparatuses 2 may need to wait for maintenance work due to a shortage of the number of persons available to perform maintenance work, thus proceeding to a step in which the schedule management unit 103 determines whether the planned maintenance can be performed ahead of schedule.

Specifically, in step S316, the schedule management unit 103 determines whether the type of the planned maintenance work is a type of maintenance work that can be performed ahead of schedule, based on the maintenance information value table (see FIG. 4). The schedule management unit 103 determines whether performing the maintenance ahead of schedule incurs the consumption (loss) of the consumable supplies to determine whether the maintenance can be performed ahead of schedule.

For example, the replenishment of paper can be determined as the maintenance that can be performed ahead of schedule because the amount of paper consumed remains unchanged when paper is replenished ahead of schedule. By contrast, the replenishment of consumable supplies such as toner or ink can be determined as maintenance that cannot be performed ahead of schedule because the replenishment of toner or ink is accompanied by the replacement of a toner or ink container (e.g., a bottle or cartridge) in use with a new container, thus incurring consumption (loss) of the residual toner or ink in the container in use when the replenishment is performed ahead of schedule.

When the maintenance can be performed ahead of schedule (YES in step S316), in step S317, the schedule management unit 103 acquires the time immediately before the job is added from the schedule of the image forming apparatus 2 (e.g., printer B) and plans the maintenance (e.g., maintenance Bm) ahead of schedule at a free time (e.g., between jobs B1 and B2) as illustrated in FIG. 8 to eliminate the time (e.g., time T1) when multiple maintenance schedules (e.g., maintenance Am and maintenance Bm) for the multiple image forming apparatuses 2 (e.g., printers A and B) overlap. In the example illustrated in FIG. 8, the plan of the maintenance Bm is changed only for the maintenance which does not cause an increase in cost of consumable supplies when performed ahead of schedule, such as the replenishment of the input tray. In step S318, the schedule management unit 103 provides a notification that the maintenance is planned ahead of schedule on the UI operation unit 102 as illustrated in FIG. 5 and ends the process illustrated in FIG. 3.

When the maintenance cannot be performed ahead of schedule (NO in step S316), the schedule management unit 103 examines whether the timing of occurrence of maintenance work can be changed by job replacement. First, in step S319, the schedule management unit 103 calculates a predicted value of the amount of consumable supplies consumed by execution of a job scheduled immediately after the added job. In step S320, the schedule management unit 103 compares the predicted value of the amount of consumable supplies consumed by execution of the job scheduled immediately after the added job with a predicted value of the remaining amount of consumable supplies before execution of the added job.

When the predicted value of the amount of consumable supplies consumed by execution of the job (e.g., job B3) scheduled immediately after the added job (e.g., job B2) is smaller than the predicted value of the remaining amount of consumable supplies before execution of the added job (YES in step S320), in step S321, the schedule management unit 103 executes (plans) the job (e.g., job B3) before executing the added job (e.g., job B2) because the maintenance due to a shortage of the consumable supplies does not occur when the job (e.g., job B3) planned immediately after the added job (e.g., job B2) is executed before the execution of the added job as illustrated in FIG. 9, thus delaying the time of occurrence of maintenance due to a shortage of the consumable supplies. In the example illustrated in FIG. 9, since the amount of toner consumed by execution of the job B2, which consumes a large amount of toner, is greater than the remaining amount of toner after the execution of the job B1, maintenance is planned and the amount of toner consumed by the subsequent job B3 is predicted. When the amount of toner consumed by execution of the job B3 is smaller than the remaining amount of toner after the execution of the job B1, the job B3 can be executed before the maintenance, and therefore, the job B2 and the job 3 are replaced with each other to shift the time of maintenance Bm. In step S323, the schedule management unit 103 compares the number of persons required to perform maintenance work for all the image forming apparatuses 2 such as printers at the same time as the newly planned maintenance with the number of persons available to perform maintenance work. When the number of persons required to perform maintenance work for all the image forming apparatuses 2 such as printers at the same time as the newly planned maintenance is equal to or smaller than the number of persons available to perform maintenance work (NO in step S323), and thus the simultaneous occurrence of maintenance can be avoided, in step S318, the schedule management unit 103 provides a notification that the maintenance is planned and the jobs are replaced on the UI operation unit 102 as illustrated in FIG. 6 and ends the process illustrated in FIG. 3.

When the predicted value of the amount of consumable supplies consumed by execution of the job scheduled immediately after the added job is equal to or greater than the predicted value of the remaining amount of consumable supplies before execution of the added job (No in step S320), the schedule management unit 103 may fail to avoid the simultaneous occurrence of maintenance because, if the order of the jobs is changed, the maintenance due to a shortage of consumable supplies still occur during the execution of the replaced job. For this reason, in step S322, the schedule management unit 103 provides a notification that simultaneous maintenance will occur and cause a shortage of maintenance performers on the UI operation unit 302 (UI operation unit 102) as illustrated in FIG. 7 and ends the process illustrated in FIG. 3. Similarly, when the number of persons required to perform maintenance work for all the image forming apparatuses 2 such as printers at the same time as the newly planned maintenance is greater than the number of persons available to perform maintenance work (Yes in step S323), in step S322, the schedule management unit 103 provides a notification that simultaneous maintenance will occur and cause a shortage of maintenance performers on the UI operation unit 302 (UI operation unit 102) as illustrated in FIG. 7 and ends the process illustrated in FIG. 3.

As described above, the information processing device 1 according to the present embodiment can prevent the image forming apparatuses 2 from waiting for maintenance work due to a shortage of maintenance performers while reducing the consumption of consumable supplies caused by the maintenance for replacement of consumable supplies being performed ahead of schedule.

A description is given below of several aspects of the present disclosure.

According to a first aspect, an information processing system includes a job information recording unit, a consumables consumption calculating unit, a maintenance planning unit, and a maintenance information storing unit. The job information recording unit records job information of one or more apparatuses including a replaceable consumable item. The consumables consumption calculating unit calculates an amount of the consumable item consumed by execution of a job of the one or more apparatuses based on the job information to obtain a calculated amount of consumption. The maintenance planning unit plans maintenance for replacement of the consumable item based on a remaining amount of the consumable item and the calculated amount of consumption to prevent the remaining amount of the consumable item from being equal to or smaller than a predetermined value. The maintenance information storing unit stores a maintenance information value table including, for each type of the maintenance, the time required for the maintenance, the required number of maintenance performers, and whether the maintenance is performable ahead of schedule. The maintenance planning unit plans maintenance performable ahead of schedule in a case where the number of users available to perform the maintenance is smaller than the required number of maintenance performers at the time when multiple maintenance schedules overlap and the maintenance performable ahead of schedule is present, based on the maintenance information value table.

According to a second aspect, in the information processing system of the first aspect, in a case where the number of users available to perform the maintenance is smaller than the required number of maintenance performers at the time when the multiple maintenance schedules overlap and the maintenance performable ahead of schedule is absent, the maintenance planning unit plans, before the maintenance, a forward movable job which is planned after the time when the multiple maintenance schedules overlap and which does not empty the remaining amount of the consumable item when executed before the maintenance.

According to a third aspect, the information processing system of the second aspect, further includes a display control unit that displays a plan change notification in a case where the execution of the maintenance performable ahead of schedule or the forward movable job is planned ahead of schedule.

According to a fourth aspect, the information processing system of the second aspect, further includes a warning unit that warns that a time during which the number of maintenance performers is insufficient is present in a case where the number of users available to perform the maintenance is smaller than the required number of maintenance performers at the time when the multiple maintenance schedules overlap and neither the maintenance performable ahead of schedule nor the forward movable job is present or the execution of the maintenance performable ahead of schedule or the forward movable job is planned ahead of schedule.

According to a fifth aspect, the information processing system of any one of the first to fourth aspects, further includes a schedule management unit that registers a schedule of the maintenance in a schedule of a user assigned as a user who performs maintenance work by the maintenance planning unit.

According to a sixth aspect, the information processing system of any one of the first to fifth aspects, further includes a remaining amount calculating unit that calculates the remaining amount of the consumable item immediately before a job is added to the one or more apparatuses to obtain a calculated remaining amount. The maintenance planning unit plans the maintenance based on the calculated remaining amount and the calculated amount of consumption.

According to a seventh aspect, an information processing method executed by an information processing device includes a calculating step, a first planning step, and a second planning step. The information processing device includes a job information recording unit to record job information of one or more apparatuses including a replaceable consumable item and a maintenance information storing unit to store, for each type of maintenance for replacement of the consumable item of the one or more apparatuses, the time required for the maintenance, the required number of maintenance performers, and whether the maintenance can be performed ahead of schedule. The calculating step is a step of calculating an amount of the consumable item consumed by execution of a job of the one or more apparatuses based on the job information to obtain a calculated amount of consumption. The first planning step is a step of planning maintenance for replacement of the consumable item based on a remaining amount of the consumable item and the calculated amount of consumption to prevent the remaining amount of the consumable item from being equal to or smaller than a predetermined value. The second planning step is a step of planning maintenance performable ahead of schedule in a case where the number of users available to perform the maintenance is smaller than the required number of maintenance performers at the time when multiple maintenance schedules overlap and the maintenance performable ahead of schedule is present.

According to an eighth aspect, an information processing device includes a job information recording unit, a consumables consumption calculating unit, a maintenance planning unit, and a maintenance information storing unit. The job information recording unit records job information of one or more apparatuses including a replaceable consumable item. The consumables consumption calculating unit calculates an amount of the consumable item consumed by execution of a job of the one or more apparatuses based on the job information to obtain a calculated amount of consumption. The maintenance planning unit plans maintenance for replacement of the consumable item based on a remaining amount of the consumable item and the calculated amount of consumption to prevent the remaining amount of the consumable item from being equal to or smaller than a predetermined value. The maintenance information storing unit stores a maintenance information value table including, for each type of the maintenance, the time required for the maintenance, the required number of maintenance performers, and whether the maintenance is performable ahead of schedule. The maintenance planning unit plans maintenance performable ahead of schedule in a case where the number of users available to perform the maintenance is smaller than the required number of maintenance performers at the time when multiple maintenance schedules overlap and the maintenance performable ahead of schedule is present, based on the maintenance information value table.

According to one or more aspects of the present disclosure, the consumption of consumable supplies due to maintenance planned ahead of schedule can be prevented while preventing occurrence of downtime due to multiple maintenance schedules.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disk (DVD), and/or the memory of an FPGA or ASIC.

1. An information processing system, comprising:
a first memory that records job information of one or more apparatuses including a replaceable consumable item;
circuitry configured to:
calculate an amount of the consumable item consumed by execution of a job of the one or more apparatuses based on the job information to obtain a calculated amount of consumption; and
plan maintenance for replacement of the consumable item based on a remaining amount of the consumable item and the calculated amount of consumption to prevent the remaining amount of the consumable item from being equal to or smaller than a predetermined value; and
a second memory that stores a maintenance information value table including, for each type of the maintenance, a time required for the maintenance, required number of maintenance performers, and whether the maintenance is performable ahead of schedule,
the circuitry being configured to plan maintenance performable ahead of schedule in a case where number of users available to perform the maintenance is smaller than the required number of maintenance performers at a time when a plurality of maintenance schedules overlap and the maintenance performable ahead of schedule is present, based on the maintenance information value table.

2. The information processing system according to claim 1,
wherein, in a case where the number of users available to perform the maintenance is smaller than the required number of maintenance performers at the time when the plurality of maintenance schedules overlap and the maintenance performable ahead of schedule is absent, the circuitry is configured to plan a forward movable job before the maintenance, the forward movable job being planned after the time when the plurality of maintenance schedules overlap and not emptying the remaining amount of the consumable item when executed before the maintenance.

3. The information processing system according to claim 2,
wherein, in a case where execution of the maintenance performable ahead of schedule or the forward movable job is planned ahead of schedule, the circuitry is configured to display a plan change notification.

4. The information processing system according to claim 2,
wherein, in a case where the number of users available to perform the maintenance is smaller than the required number of maintenance performers at the time when the plurality of maintenance schedules overlap and neither the maintenance performable ahead of schedule nor the forward movable job is present or execution of the maintenance performable ahead of schedule or the forward movable job is planned ahead of schedule, the circuitry is configured to warn that a time during which the number of maintenance performers is insufficient is present.

5. The information processing system according to claim 1,
wherein the circuitry is further configured to register a schedule of the maintenance in a schedule of a user assigned as a user who performs maintenance work.

6. The information processing system according to claim 1,
wherein the circuitry is configured to:
calculate the remaining amount of the consumable item immediately before a job is added to the one or more apparatuses to obtain a calculated remaining amount; and
plan the maintenance based on the calculated remaining amount and the calculated amount of consumption.

7. An information processing method, comprising:
calculating an amount of a replaceable consumable item consumed by execution of a job of one or more apparatuses including the consumable item based on job information of the one or more apparatuses to obtain a calculated amount of consumption;
planning maintenance for replacement of the consumable item based on a remaining amount of the consumable item and the calculated amount of consumption to prevent the remaining amount of the consumable item from being equal to or smaller than a predetermined value; and
planning maintenance performable ahead of schedule in a case where number of users available to perform the maintenance is smaller than required number of maintenance performers at a time when a plurality of maintenance schedules overlap and the maintenance performable ahead of schedule is present.

8. An information processing device, comprising:
a first memory that records job information of one or more apparatuses including a replaceable consumable item;
circuitry configured to:
calculate an amount of the consumable item consumed by execution of a job of the one or more apparatuses based on the job information to obtain a calculated amount of consumption; and
plan maintenance for replacement of the consumable item based on a remaining amount of the consumable item and the calculated amount of consumption to prevent the remaining amount of the consumable item from being equal to or smaller than a predetermined value; and
a second memory that stores a maintenance information value table including, for each type of the maintenance, a time required for the maintenance, required number of maintenance performers, and whether the maintenance is performable ahead of schedule,
the circuitry being configured to plan maintenance performable ahead of schedule in a case where number of users available to perform the maintenance is smaller than the required number of maintenance performers at a time when a plurality of maintenance schedules overlap and the maintenance performable ahead of schedule is present, based on the maintenance information value table.
